(19) United States
(12) Patent Application Publication
(10) Pub. No.: US 2024/0336183 A1
(43) Pub. Date: Oct. 10, 2024

(54) VENDING APPARATUS, SYSTEM AND METHOD FOR VENDING ITEMS IN A VEHICLE

(71) Applicant: RIDY PTE. LTD., Singapore (SG)

(72) Inventors: Boris Dmitri BOLSHCHIKOV, Yekaterinburg (RU); Alexey Borisov KHALYAVIN,, Dolgoprudniy (RU); Petr Andreevich GRESHNOV, Yekaterinburg (RU)

(21) Appl. No.: 18/573,694

(22) PCT Filed: Jun. 23, 2022
(86) PCT No.: PCT/RU2022/050198

§ 371 Date: Dec. 22, 2023

(30) Foreign Application Priority Data
Jun. 29, 2021 (RU) 2021118910

(51) Int. Cl. B60N 3/00; B65G 1/137; G07F 7/10

(52) U.S. Cl. CPC B60N 3/00; B65G 1/1371; G07F 7/10; B65G 2203/0216

(57) ABSTRACT

The invention relates to the area of vending technologies, in particular to the vending apparatuses, that can be installed in passenger carrying vehicles, as well as to the means and methods of vending using such apparatuses that enable automated sales of items, including the sales happening during ride-hailing, ridesharing, an autonomous taxi ride and use of a public transportation. Technical result achieved when the claimed group of inventions used is in increasing safety and integrity of the vending system, that is installed in a vehicle and used by both a passenger and a driver (or by a supplier, an independent vending service provider), while maintaining both the reliability of the system elements and the ergonomics of the vehicle interior. Thus claimed result is achieved by realization of the vending apparatus tailored to be placeable in a vehicle cabin as a removable transformable medium for storing and selling items, that contains the flat base, to which the plurality of the storage partitions is attached to, with individual access to each partition's content, and at least one closure element for the set of storage partitions that secures at least one partition by reversable fastening of its edge to the flat base, as well as the access-management devices associated with the a closure element, which perform functions of a sensor and/or a lock and/or a locking-sensor, connected with at least one board controller that manages the aforementioned devices of the vending apparatus's with the capability of data or signals exchange. The system for vending items in a vehicle cabin includes at least one vending apparatus described above, personal computing devices of a user and/or a supplier, equipped with installed software program enabling data exchange with the databases of the vending system, as well as a means of identifying a specific vending apparatus and/or a specific user that is to use it. The apparatus claimed, as well as the vending system based on it, are characterized by a high degree of ergonomics and transformability, as well as modularity of elements, which enable ease of transportability of the vending apparatuses or its elements, high level of safety and integrity of the vending system operation from each participant's side (a user and a driver or a vending service supplier).

### FIELD OF INVENTION

The invention claimed is related to the field of vending, comprising the vending apparatuses that are installed mainly in public transportation and passenger vehicles, for example, in taxis, carsharing, carpooling, buses, trains, or airplanes, etc., as well as to the means and methods of vending using the vending apparatuses that enable automatic sales during a ride or use of public transport.

### TECHNICAL LEVEL

Vending has been one of the fastest growing segments of retail over recent decades. Trade channels that are enabled through specialized autonomous and automatic apparatuses have gained popularity equally among producers, suppliers, retailers, and consumers of various products. Vending apparatuses and systems find their application in almost every area of modern life. Such apparatuses automate several functions simultaneously and remove the need for merchandizer, salesman, or cashier. Recent technologies have been advancing significantly across design and construction of vending apparatuses, systems for payment used in them, as well as methods and systems for automating replenishment of inventories and monitoring conditions of vending apparatuses or consumer behavior.

Nowadays, the vending apparatuses for sales of a wide range of the fast-moving consumer goods, both food and non-food, are well known. Such apparatuses usually are installed in crowded places, in public areas, for example, shopping malls, waiting halls, stations of public transit, etc. The vending apparatuses designed to be installed in space-limited spots are less common. Even less developed the solutions for vending in transport (public transportation vehicles, taxi, air travel, etc.), where space is critical factor for both safety and comfort of a passenger. Meanwhile, modern automation and digitalization technologies make it possible to use public transport as mobile points of sales for food and drinks, hygiene items or other goods that increase the comfort for a passenger. Opening such new retail channels is of high interest of companies that produce those goods, that are usually purchased on-the-way, while impulse shopping behavior of consumers fades out with growth of online commerce. Meanwhile providers of transportation services and e-hailing aggregators seek for solutions to improve their competitive advantage, differentiation or increase an income of their drivers, where in-vehicle vending can be a significant opportunity.

A vending apparatus for a vehicle (U.S. Pat. No. 10,793,044) is known from the prior art, comprising a product housing positioned in a vehicle, the product housing including an exposed surface having a product delivery opening; a removable inventory cartridge; a product dispensing mechanism including a product dispensing opening, the product dispensing mechanism being configured for dispensing a product from the removable inventory cartridge in the product housing to the product dispensing opening; a product delivery conduit including a first end and a second end, the first end being joined with the product dispensing opening and the second end defining a product delivery opening, which is formed in the exposed top surface of the product housing and positioned in a passenger compartment of the vehicle; and a lifting mechanism positioned within

the product delivery conduit for mechanically lifting the product dispensing opening to the product delivery opening.

The apparatus requires a significant amount of space for installation, which is not always possible, for example, in smaller vehicles or vehicles that are not designed to have sufficient room in the trunk. Besides, this device possesses significant complexity that requires special capabilities and certain skills for installation, use, inventory management, and maintenance. It also requires significant involvement from a driver or other person who provides vending service.

Among the in-vehicle vending apparatuses there is the method of vending utilizing the apparatus (US20110071669), which is also placed in a trunk. The vending apparatus dispenses items to the consumer without the driver's participation. The passenger selects the goods on display and pays for it at the end of a ride (the sum for the items sold is added to the cost of a ride).

Though this solution requires the participation of a driver in the process of maintaining the inventory in the apparatus, it helps to reduce the driver's involvement into the processes related to sales, including payments and replenishment. It becomes possible since the implementation of the vending apparatus itself involves preliminary modification of a vehicle, equipping it with additional stationary means of storage in the trunk, transferring of items through the rear compartment, as well as with means of communication with a server to exchange information on purchases and inventory.

A mobile vending system as per US20040249502 includes the following items: a housing with inner and outer parts, where the housing is adapted to be embedded in a vehicle; at least one compartment placed inside the housing for storing multiple items; a dispensing system where items sold are transferred from at least one storage compartment to the outside of the housing; and at least one selector device connected to the dispensing system. The process of selection and dispensing of items is managed via a pre-installed software program, which allows vending to be contactless. The purchase amount is also added to the cost of a ride, in the case of using this system in a taxi, cab, or carsharing.

The apparatus cannot be used outside of the transportation management system. In addition, the characteristics of the device indicate the need for its integration into the cabin interior and the potential need for replacing its standard components or their modification in view of the significant global diversity of car interiors.

The vending system disclosed in U.S. Pat. Nos. 10,853,862 and 10,699,258 are the closest to the claimed group of invention. This system is characterized by comprising a vending apparatus capable of being placed in a car, a user authentication means, and a vending system, which is embedded into the transportation management system and its mobile application. The vending apparatus is designed to be a box with one locking device and one closure element that provides access at the same time to one or more items, that are being sold. The vending apparatus is equipped with various devices that provide automated and unobtrusive monitoring of the inventory. For example, hardware components, including sensors, cameras, displays, and other related components, can be used to determine which items were picked up during the vending session trading session, in addition to confirming that those items match the items requested by a user. The in-car vending apparatus can interact with the transportation management system to optimize ways to provide access to and purchase of items displayed. For example, an in-car vending apparatus and the vending systems retrieve user information from the transportation management system to authenticate simultaneously the user, the vending apparatus and the beginning of the vending session, and then associate the purchase made with the ride, allowing the user to select one or more items to purchase, and then confirm the purchased items after the ride and the vending session are finished and send a detailed receipt to the user.

One of the design drawbacks of this apparatus is the low physical visibility of all the items, being sold, in the apparatus.

Implementation of the apparatus with a single locking device associated with one closure element leads to a lack of control over individual items. Once the locking element is unlocked and the closure element is opened, there is a risk of withdrawal not only of the purchased items but also the others. Thus, the standard vending approach, where each item becomes available to a shopper separately and independently, is not realized. To secure the vending system, the inventors come up with the need to organize the operation by the vending sessions, where access is provided to the entire apparatus inventory directly and not to individual items. During or at the end of the vending session, the control and monitoring of the inventory and the purchased items is required, which is realized through thus needed sensors in the apparatus.

Since the apparatus provides access at the same time to one and more items, that are being sold and there are many possible users, it is necessary not only to monitor items stored and purchased before, after, or during the vending session but to authenticate the user prior to the vending session to manage safety and security concerns, though only retrospectively.

To manage payments and mitigate potential losses when incorrect items are withdrawn, the use of the vending apparatus requires direct association of the vending session and the verified user and his account, which under the claimed inventions can be managed through the transportation management system and the ride session associated with the user. Thus, an independent and impersonalized (for example, outside the transportation management system) use of the vending apparatus within the disclosed framework is not possible.

Thus, the currently known systems and methods of vending in transport either use standard mechanized approaches of conventional vending apparatuses for separate access to items in the inventory, which leads to challenges in installation or use of a vending apparatus (replacement of standard parts, reduction of the space in the cabin and/or comfort for a passenger, the need to adapt the apparatus design for each vehicle), or change the methods of vending, using a miniature apparatus with simultaneous access to one or more items, which leads to the need for enhancing safety, security, and integrity of the vending system through reduced privacy; data exchange between the apparatus and the transportation management system; use of sensors to prevent or manage errors, theft, or fraud; or mandatory user authentication prior to the vending session.

Among other things, all the above-mentioned means (vending apparatuses) are characterized by the use of rigid materials in housings and by the volumetric form factor, which limit applications of the known apparatuses in transport and vehicles in view of a passenger's comfort and safety. Thus, the technical problem solved by the claimed invention contains in the need to overcome the disadvantages and challenges inherent to the analogues, by creating a vending apparatus that is compact, portable, transformable, yet secure and safe in operation, when placed in a vehicle and used during a ride, as well as creating a secure system and method for the contactless vending in a vehicle, enabling quick replenishment of inventory and execution of a sale during a ride without involving a driver and with use of online platforms.

### BRIEF DESCRIPTION OF THE ESSENCE OF THE INVENTION

The technical result achieved if the claimed group of inventions is used, lies in the increase of the security, integrity, and safety of the in-vehicle vending method, system and apparatus for both a passenger and a driver (or/and a vending service provider), and the reduction of complexity and form-factor of the in-vehicle vending apparatus, while maintaining both the reliability of the system elements and the ergonomics of the vehicle interior.

The claimed technical result is achieved due to the vending apparatus, that is made suitable for installation in a passenger vehicle, according to the technical solution, is a removable transformable means of storing and selling items, comprising a flat base with a plurality of storage partitions mounted to it, implemented with the possibility of individual access to each said partition, and equipped with at least one closure element, that secures at least one partition and the partition's side attachment to the flat base, as well as access management devices that are connected with the possibility of exchanging data or signals with at least one controller board that manages indicated devices, associated with the storage partitions of the vending apparatus. The means of storing and selling items is configured in the way to be placed on the back of at least one car seat or between adjacent seats of a vehicle so the front of the partitions and the flat base is visible to a passenger. The flat base can be made flexible, formed from plastic or textile, including fabric materials. The storage partitions are made of flexible materials that enable visibility of an item to a passenger, including mesh plastic, fabric or metal materials or transparent plastic films. The vending apparatus can contain at least one stiffening rib, and its storage partitions can be made removable. The apparatus is additionally equipped with electrical charging system for external devices and/or backlighting and/or interactive systems, including an information display, a microphone or a speaker. Textile fasteners and/or plastic zippers, including the hook-and-loop fasteners, are used as the closure element. An electromechanical or magnetic, or combination lock, or contact locking devices are used as the locking devices managing access to a said partition. Sliding locks or autonomous zippers, that can automatically move along closure element, are used as locking devices, which manage access to several storage partitions at the same time. Autonomous sliding locks with their unique controllers, which manage independently access to several storage partitions are used as locking devices. Sliding locks that manage access to several storage partitions at the same time and capable of detecting the number of partitions that has been accessed and the number of items to be paid, are used as the lock-sensors. The sensing devices are capable of registering state of closure element or/and the moment of opening a storage partition or/and presence/absence of item in a partition and are connected to the corresponding controller board. A photosensor or complex sensors are used as sensor devices as well. The controller board of the vending apparatus is equipped with an autonomous power supply or is configured to be powered from a vehicle. Each storage partition is associated with the board controller, that governs the access management devices linked to the storage partitions. The board controller is equipped with a module that maintains independent internet connection. The controller is designed to be directly and securely connected to external electronic devices. The vending apparatus is designed to be connected to such systems of a vehicle as air conditioning, heating or climate control, and may contain independent devices for cooling the base of an individual partition to control temperature of an item in it. Said flexible flat base can be made as a part of the seat cover or other elements of the vehicle interior. The flexible base and elements of the storage partitions can be equipped with heat-reflecting and/or air-tight elements that provide the ability to regulate the air temperature in the storage partitions, as well as their thermal insulation. The partitions can be combined into removable modules. The vending apparatus can be equipped with an interactive touch screen device that enable functionality of payments, user identification or communication. The claimed technical result is achieved also by creating the system for the vending items in a vehicle, comprising at least one vending apparatus of claims 1-24, computing devices of a user and/or a supplier, with the software program that enables data exchange with data base of the system for vending, as well as a tool for identification of a specific vending apparatus and/or a specific user. The identification tool is a unique tag or ID, quick response code, symbolic code, bar code. The vending apparatuses within the system or their storage partitions or the modules, containing several partitions, are made interchangeable between each other. The system can additionally include at least one distribution center enabling logistics of items being sold, where the software program enables communication and exchange of data between with the apparatuses and/or individual computing devices of users and/or suppliers and other units within the system. The distribution centers are equipped with equipped with automated devices for replacement of the vending apparatuses. The distribution center can be mobile, being made of a vehicle equipped with the automated device for replacement of the vending apparatuses. The claimed technical result is also achieved by the applying the method of vending in a vehicle using the system of claims 25-30, comprising step of placing the vending apparatus of claims 1-24 into a passenger compartment of at least one vehicle, where the apparatus's partitions are filled with items intended for sale; updating the database of the vending system with information about the apparatus, items in it and its link to a particular vehicle and/or supplier; activation of a software program by a user that enable selection of items and payment process, mutual identification of a vending apparatus and the user in the system, selection and payment of the goods by using the interface of the apparatus and/or the software program, granting user with access rights to the storage partition followed by withdrawal of the selected item. To identify the vending apparatus, one enters a code of the vending apparatus into the software program. The software program can be activated via the interface of the vending apparatus or via the user's computing device. In a particular case, a user completes preliminary registration of own computing device in the software program, while for user identification by the vending apparatus the special user's identification information can be used, including biometric or payment data, that is entered into the software program. Payment can be managed via pre-paid subscription, or initiated based on user's control information, including code, voice, phrase and/or pre-entered payment data, or using contactless payment methods or a fast payment service, or automatically in accordance with the user's payment details, that are pre-entered into the software program. Granting a user with access to the partition is carried out as a result of the unlocking the access management device associated with the partition by the controller. The partition can be unlocked by entering a code provided to the user by the software program during. The state of the vending apparatus is recorded additionally by registering signals from the sensing devices of the vending apparatus before and after the sale. In the process of such recording a photo of the vending apparatus can be taken and used additionally. In this case, as a result of recording state of the vending apparatus, information on the inventory of items in it is obtained and shared to the distribution center for making a decision and the need to replenish inventory or replace the vending apparatus or its parts. The moment of withdrawal of the selected and paid items is also managed by recording the state of the vending apparatus after purchase completion by one of the users of the vending system.

The claimed invention is also characterized by such technical advantages as compactness, utility and transformability of the vending apparatus. The materials which the vending apparatus's base and partitions made of can be flexible and significantly lighten the weight of the device, increasing the safety of its use when placed in a vehicle. Exclusion of a vehicle driver from vending process, especially purchase and withdrawal, enables continuous access of a user to the vending apparatus during whole ride and improves safety for both a driver and a user of the system. The capability of the vending apparatus to grant individual access to the separate storage partitions provides additional level of security to the items in them, enable the integrity of the system, and safety for both a supplier or a driver and a user. Removable modules with grouped storage partitions enable their easy interchangeability and the ability to quickly replenish the vending apparatus inventory. The system claimed is characterized by a simple and intuitive interface.

### DESCRIPTION OF FIGURES

The invention claimed is illustrated by the following figures, where

in FIG. 1 (a, b, c, d) appearance of the vending apparatus located in a car is demonstrated;

FIG. 2 shows the multilayer structure of the vending apparatus claimed, and the possibility of its folding is presented;

FIG. 3 (a, b, c) shows schematically options for stationary access management devices that are made as sensing devices;

FIG. 4 (a, b, c) shows schematically options for stationary access management devices that are made as locking devices;

FIGS. 5 (a, b, c, d, e) and 6 schematically represent the sliding and movable access management devices that govern access to the partitions of the vending apparatus;

FIG. 7 shows a variant of a typical construction of the sliding and movable locking device,

in FIG. 8 the removable modules containing grouped storage partitions and additional components of the vending apparatus are presented;

FIG. 9 shows the removable modules containing several storage partitions, which secured by the sliding and movable access-management devices and one closure element;

FIG. 10 shows a version of the vending apparatus embedded into the standard elements of a vehicle seat,

FIG. 11 shows schematically the infographics about the implementation of the claimed vending method,

FIG. 12 shows examples of the typical interface of the software program for a supplier or a driver,

FIG. 13 shows examples of the typical interface of the software program for a user of the vending apparatus,

FIG. 14 shows a photo of a prototype of the system.

Positions in the figures indicate:
1. vending apparatus,
2. flat base,
3. storage partition,
4. tools for fastening the base,
5. control-locking devices,
6. multi-layer base,
7. outer layer of the multi-layer base,
8. additional functional elements,
9. pockets for placing electronic components,
10. stiffener,
11. sections of the flat base,
12. partitions of different sizes,
13. closure element,
14. access management devices,
15. microcontroller or board controller,
16. locking devices,
17. photosensors,
18. sensor associated with a partition,
19. tag on an item,
20. camera,
21. stationary locking devices,
22. components of a closure element,
23. electromagnetic locks,
24. component for mounting the locking device on the front side of the flat base,
25. component for mounting the locking device on the inner side of the flat base,
26. visible part of component 24,
27. voltage or current,
28. electric motor,
29. information exchange,
30. sensors for collecting biometric information,
31. actual combination on the combination lock,
32. movable or sliding access-management device
33. movable sensing device,
34. guide rail,
35. stop-locking device,
36. autonomous sliding lock or “movable lock”,
37. group of partitions,
38. group of partitions with single closure element,
39. external power source,
40. internal battery,
41. first port,
42. second port,
43. microcontroller integrated into a lock,
44. electric motor or stopper,
45. mechanical elements,
46. guide rollers
47. closure guide element,
48. mechanical elements of the lock,
49. the lower part of the lock,
50. fasteners,
51. mechanical system,
52. zipper,
53. removable modules,
54. additional devices,
55. vending apparatus options with different functionality,
56. fastening elements,
57. mount locking elements,
58. mount closure elements,
59. master closure element,
60. master closure locking components,
61. back cover,
62. USB-port for device power supply,
63. separator between adjacent partitions,
64. place for visual and information and advertising,
65. transparent pocket,
66. identification tool,
67. vending apparatus embedded into a standard vehicle seat,
68. vehicle interior,
69. external data storage,
70. supplier of vending service,
71. computing device of a supplier's service,
72. user of the vending system,
73. computing device of a user,
74. software program,
75. transportation management system,
76. data storage of a transportation management system,
77. wireless connection of a supplier's device and the controller of vending apparatus,
78. internet connection of the supplier's device and data storage 69,
79. connection of the vending apparatus device with the vending system databases via embedded module of the controller for connecting to telecommunication networks,
80. wireless connection of the user's device and the controller of the vending apparatus,
81. connection of the user's device and data storage 69 via internet,
82. user interaction with the software program interface on the user's device,
83. interaction of a user with the devices of the vending apparatus,
84. emptied vending apparatuses,
85. filled vending apparatuses,
86. plurality of vending apparatuses 1 placed in different vehicles,
87. points for exchange of vending apparatuses, associated with the distribution center,
88. mobile point of replacement of the vending apparatus,
89. board controller of equipment for exchange of the vending apparatuses,
90. camera for collecting information,
91. slot for receiving emptied vending apparatuses
92. slot for dispensing filled apparatuses,
93. device associated with the supplier of service for exchange of vending apparatuses,
94. different ride-hailing vehicles used within and outside of different transportation management systems,
95. vehicles used simultaneously by several independent users,
96. vehicle temporarily disconnected from the Internet during passenger transportation,
97. registering of items being placed into the apparatus's inventory,
98. view of the vending apparatus inventory,
99. pairing of the vending apparatus with the device of a user or a supplier,
100. governance of access-management devices of the vending apparatus,
101. recording state of the vending apparatus, inventory, and items via image recognition functionality of the software program,
102. functionality of managing representation of inventory and appearance of the vending apparatus,
103. functionality of automatic identification of the vending apparatus by a user,
104. functionality of selecting items from the inventory of the vending apparatus,
105. functionality of selecting items form of the vending apparatus partitions represented in the software program,
106. functionality of payment gateway,
107. recording and recognition of the state of apparatus after withdrawing items by a user,
108. providing feedback on the supplier's service.

### IMPLEMENTATION OF THE INVENTION

The group of the claimed inventions includes a vending apparatus, which is a mobile media for storing and selling items, a system and a method for vending of those items in a vehicle.

The vending apparatus 1 contains a flat base 2, to which the storage partitions for items 3 are mounted. The flat base can be flexible and made, for example, of plastic and textile materials (for example, leather, leather substitutes, nylon, or cover fabrics) and has a shape that is conformal to the interior elements to which it is intended to be attached. The base can be equipped with the fastening tools 4 to the back of the vehicle seat, for example, nylon straps or elastic fastening straps with buckle clips, like fastexes. The fastening tools can be equipped with additional control-locking devices 5 (for example, code, mechanical or electromechanical locks or sensors) for installation in vehicles without a driver, or a representative of a supplier of the vending system and the transportation management system, such as carsharing, rental cars, public transportation vehicles 95, or autonomous driverless vehicles. The installation of such tools 5 secures the system against the possible unauthorized removal of the vending apparatus from a vehicle.

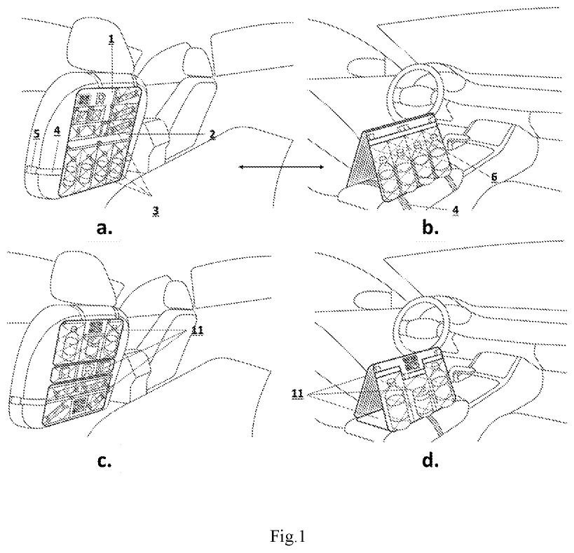

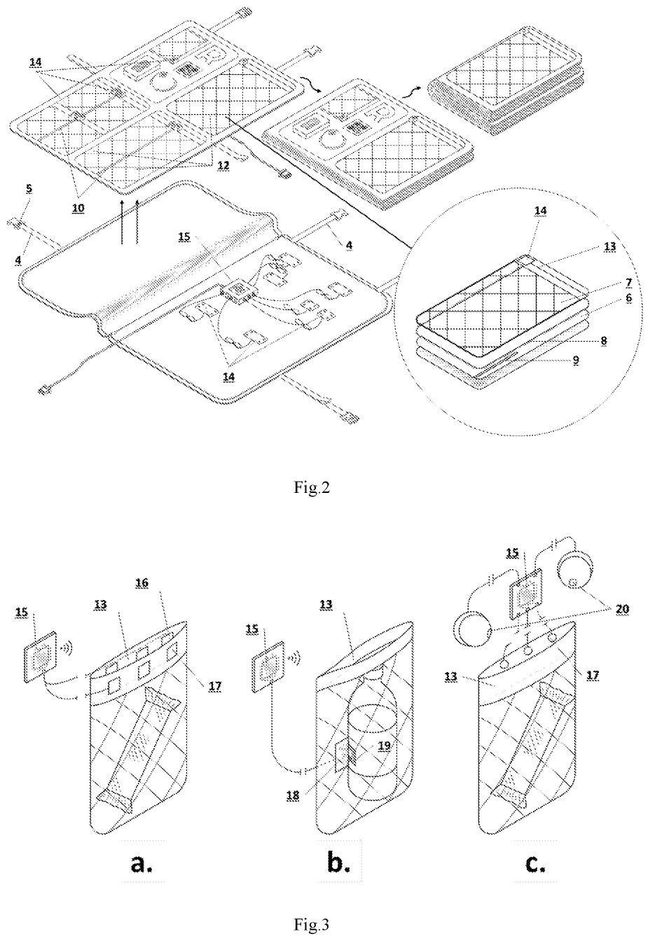

The flat base with the storage partitions due to the use of flexible materials, can be easily removed, folded, compacted, and be carried in both folded and unfolded states. The flat base can be designed as a multi-layered 6 in order to achieve certain functional and stiffness characteristics. For example, the outer layer 7 associated with the partitions can be made of mesh, stretchable or flexible transparent materials. The inner layers can be made of denser fabrics or contain rigid inserts to keep shape the apparatus. The presence of internal or external layers allows the installation of additional functional elements, such as zippers 8 (that, for example, enable fastening of removable storage partitions) or channels and niches 9 for placing electronic components. The apparatus may have stiffening ribs 10 which help to keep the shape of the apparatus when folded or emptied. The combination of such rigid and flexible elements in the structure ensures the transformability of the device (it may be necessary, for example, for installation on an armrest or easier hand carrying in the form of a bag—FIGS. 1, 2), as well as its folding (FIG. 2) when needed.

The base of the apparatus can be made of several sections which provide the possibility of apparatus transforming. For example, the presence of three sections 11 (FIG. 1), allows to transform the flat base into a pyramidal shape, where the bottom is formed from the middle section. This transformation makes the apparatus easier to carry (the “bag” form) or to install it onto flat surfaces of the vehicle interior, for example, on the armrest or the compartment between seats.

The size of the storage partitions can be different within one vending apparatus for placing items of different dimensions. The apparatus 1 (FIG. 2) has partitions of a larger size for bottled water, and other partitions of a smaller size for placing, for example, mini-snacks or bars. Small storage partitions can be designed to hold small items such as chewing gum, mini headphones, wet wipes, etc.

The mentioned above and other items are placed in different-sized partitions 12, which are closed storage zones for items being vended. The storage partitions can be individual—for each item of goods; or group—for a group of the same type of goods, or different goods. The partitions on at least one side can be made of materials that allow visibility of items, for example, in the form of mesh pockets or pockets of transparent flexible plastic.

The storage partitions of the apparatus can be equipped with at least one closure element 13, which secures attachment the partition (or its side) or the module of partitions (or one of their sides) to the flat base. For example, textile fasteners and/or plastic zippers, including fasteners of the “zipper” or “hook&loop” types, can be used in such closure elements.

To control the access to the partitions (for the withdrawal or replenishment of goods), the apparatus is equipped with stationary, movable, or mobile access management devices 14, connected to at least one central board controller or individual microcontrollers (15). The controller may contain integrated micro components, tools, circuits or installed algorithms for different purposes: recognizing user movements utilized in automation of the vending apparatus operations and geolocation; as well as also may possess functionality for working with various sensors and devices associated with or comprising in the vending apparatus (cameras, photosensors, displays, speakers, microphones). During installation of vending apparatus in autonomous driverless vehicles or the vehicles of a car-sharing service, it is preferable to use a board controller 15 with an independent module connecting it to the Internet or to pair the apparatus with the vehicle devices. Controller 15 is mounted onto a flexible flat base with the ability to connect to a vehicle power source or an autonomous power supply. The power supply system of the vending apparatus, in general, provides the ability to connect to the vehicle's standard power supply system via a USB port, for example, in the central panel or via the automobile auxiliary power outlet. The vending apparatus claimed may have an integrated wireless communication module for transmitting signals with its access management devices. The device can have a universal port for recharging mobile devices and an integrated diode lamp. It is also possible to equip the device with an information display. Devices of a vending apparatus in common way of deployment have a degree of protection (provided by their enclosures) against dust and moisture not lower than IP-45 in accordance with Russian Federation GOST 14254-2015/96.

Access management devices 14 are installed with the ability to be controlled by one or more microcontrollers, enabling locking of the storage partitions and/or recording the state of the vending apparatus and its component. Those devices can be connected to the controller via either wired or wireless way. Microcontrollers 15 can also be located individually in each access-management device and installed with the possibility of individual or centralized connection (via central controller) to the user's device (for example, a smartphone) via wireless communication channels.

The devices 14 can perform only a sensing function providing control over access to at least one storage partition, becoming the sensing devices. Such sensing devices monitor the state of the partition using sensors or additional devices, information from which is transmitted to at least one microcontroller 15 of the vending apparatus via wired or wireless communication. The sensing devices can be designed based on paired contacts, or electromagnetic sensors 16 (FIG. 3) integrated into the closure element or photo sensors 17. Access management via sensing devices also can be carried out by a system comprising the storage partition sensor 18 and a corresponding tag 19, placed in advance on an item being vended (for example, radio-frequency identification, or electromagnetic tag). This method of using sensing devices in access management allows identification of a product and storage partition and monitoring of inventory if multiple tag types are used or a tag is unique for each individual item. Alternative sensing devices for monitoring the state of the apparatus, partitions or recording the direct actions of the buyer,—are the cameras 20, which transmit the visual information to cloud databases associated with automatic analysis algorithms, or the information is analyzed directly by the board controller of the apparatus.

The sensing devices enable registration of an event when one opens the storage partition and can record the number of items withdrawn from the storage partition. Use of the sensors is also convenient when the partitions are not equipped with other access management devices, such as the locking devices, preventing unauthorized entry into the partition. Thus, recording of opening closure elements associated with the storage partitions, withdrawal of items from partitions or filling the inventory of apparatus can be carried out by the sensing devices installed onto the vending apparatus, including the sensors of opening and closing of the closure elements, the sensors inside the storage partitions, and also the sensors of interaction of the vending apparatus devices with sensors or tags attached to an item (or its parts), that are being vended, as well as the sensors (photo/camera sensors) recognizing the integrity and identity of items. These sensors transmit information about the customer's actions via controller to the cloud database and trigger signal for the payment system or a signal to a transport service employee, supplier or driver.

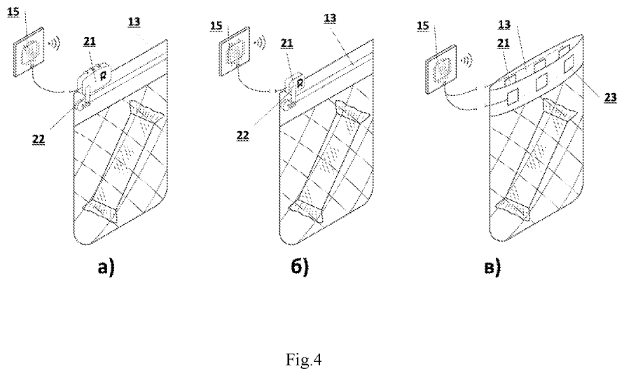

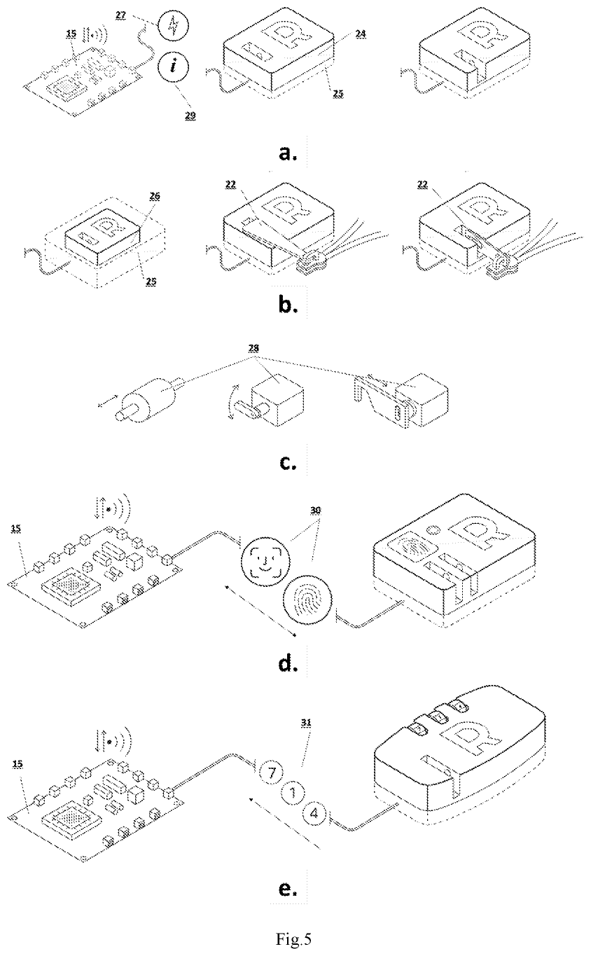

Devices 14 can perform only a locking function, becoming the locking device for access management. For example, the locking devices 21 of the stationary type provide controlled access to the content of vending apparatus storage partitions (FIG. 4). These devices carry out controlled locking and unlocking of the components of the closure elements 13 of the vending apparatus. Such components can be designed as a puller 22 in the slider of a textile or plastic zipper, or buckle clips (fastexes), or surfaces of electromagnetic locks 23 that are integrated into the closure element associated with the storage partition.

The components associated with the closure element themselves can also act as locking devices. For example, a slider of zipper equipped with a stopper controlled by the controller 15 wirelessly or via wired contacts inside the zipper chains or teeth, or two opposite longitudinal zipper segments (chains) can be made as an electromagnetic pair, being attracted in the absence of voltage, locking the closure element and its partition, and, conversely, repelled when voltage is applied on one of the segments, allowing the slider to move along freely.

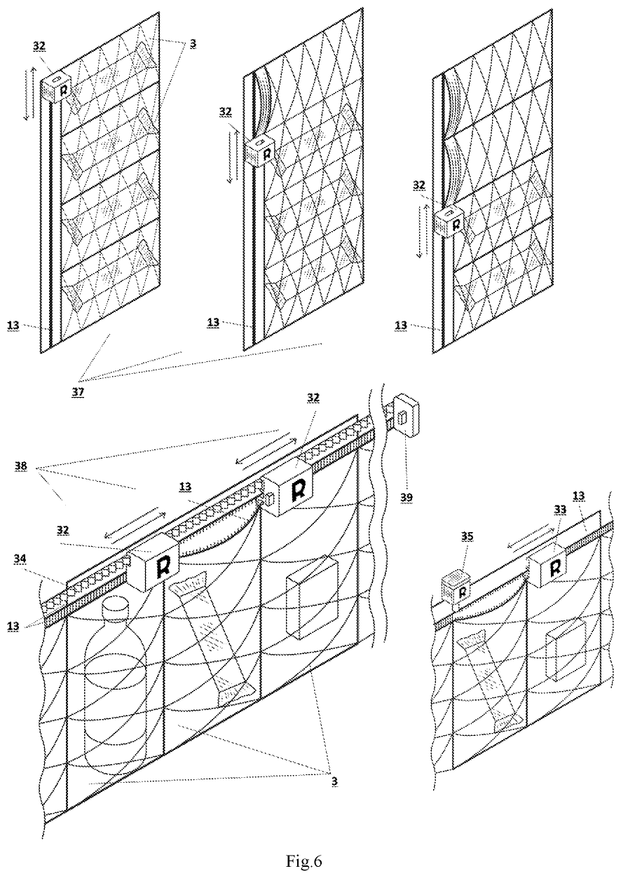

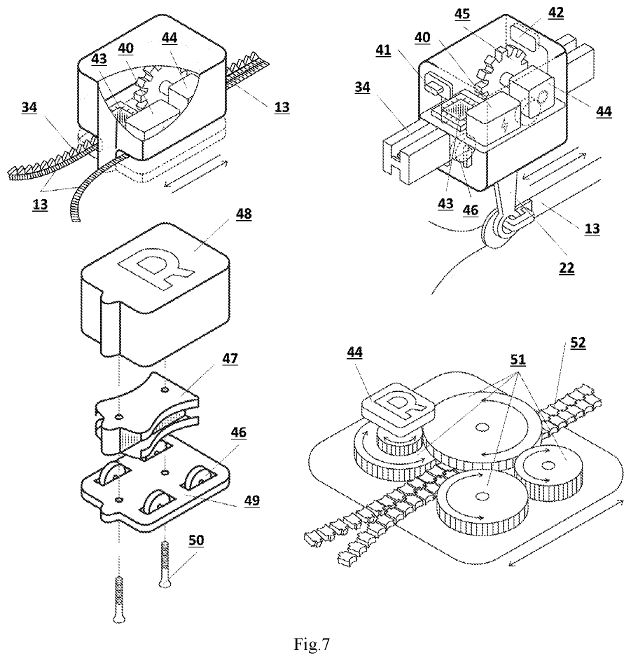

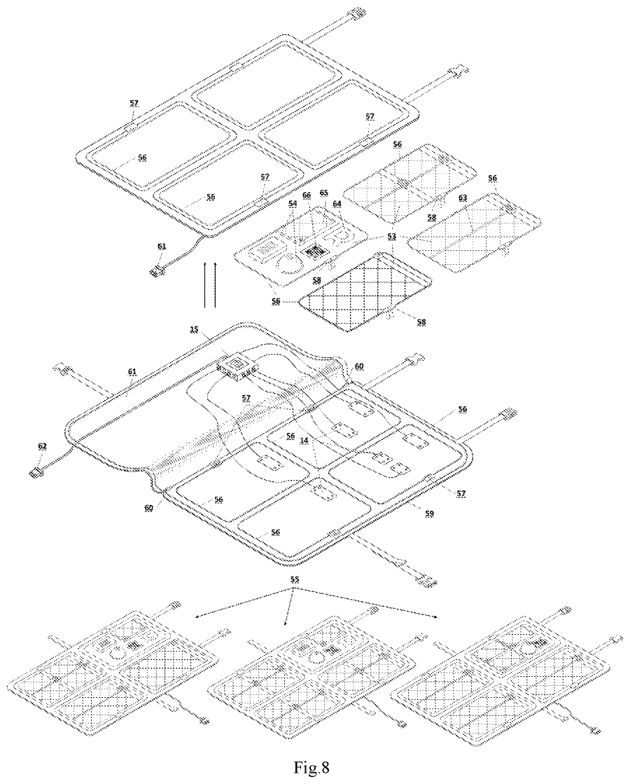

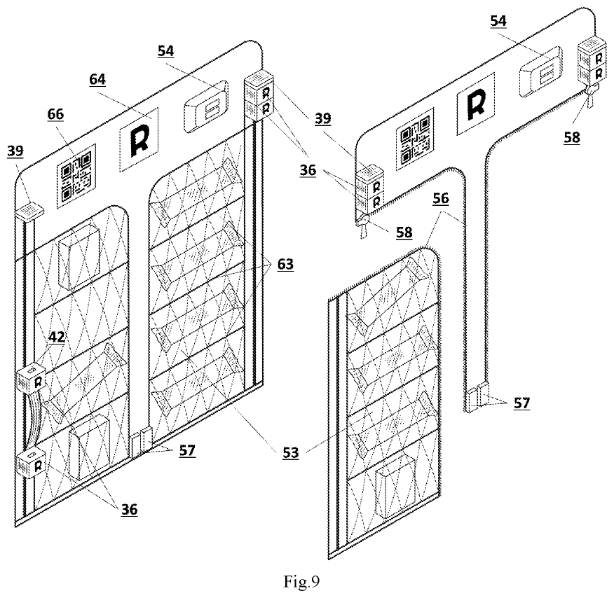

The locking devices can be mounted to the flat base of the vending apparatus by means of two components, one of which (24) is connected to the front side, and the other (25)—to the back side (FIG. 5). The size of the visible part 24 can be minimized by placing the main work items of the device into the visually hidden part 25. This maximizes usage the surface of the vending apparatus base, for example, increasing the number or size of the storage partitions, as well as making possible to install additional interactive devices in freed up area.

The microcontroller 15 can control the supply of voltage or current 27 to the elements of the locking device 21. FIG. 5 shows variants of the locking device in the form of “locks” for a textile zipper and its slider. The miniature electric motor 28 of such locks is initiated by the controller, and when the mechanical elements and actuators, associated with the motor, move (various movements type, such as rotation, twisting, displacement, or other necessary steps to activate the locking mechanism(s)), the lock is locked or unlocked. The microcontroller can also exchange information 29 with the lock elements such as sensors, additional controllers and devices. In one of the design options of the vending apparatus lock, sensors are used to collect biometric information 30, which is then analyzed and compared with the reference to unlock the locking device.

It is also possible to implement a passive locking device where the microcontroller just collects information about the state of the locking device but does not control the locking process. For example, using of a mechanical combination lock together with sensors and microcontroller allows collecting and transmitting information about the state of the lock (the current combination on the lock 31, or data on the moments of changing the combination, or data on the access combination, or data on changing the access combination) to the cloud databases for different ways of managing access rights to a storage partition, including providing the actual access code for the partition to the buyer after the payment is carried out.

The opening of the closure element (for example, a zipper) of the storage partition is carried out manually by a user after the locking device has been triggered and the components associated with the closure element (for example, a slider) are unlocked. After withdrawing the product from the storage partition or closing the partition closure elements by a user, an automatic reverse locking mechanism is triggered.

Management of access to the apparatus partitions can be carried out by movable or sliding access management devices 32: the movable sensing devices 33 or movable locking devices 36 (FIG. 6), coupled with the closure element 13.

The devices 33 are sensors equipped with their own microcontrollers that collect and transmit information about the position of the device relative to the closure element or the guide 34 to identify the state of the storage partition. The closure element of partitions itself can have additional labels, including photo- or electromagnetic ones, for identification of the partitions. The movement of the devices 33 along the closure element 13 or the guide 34 is carried out directly and manually by the user of the vending apparatus after receiving instructions from the software program. The closure element with the installed movable sensing device 33 can be also equipped with a stop-locking device 35, which restrict the movement of device 33 along the guide or closure element 13.

The access management device 32 containing a stopper, motor or other mechanisms inside that control its movement along the closure element may have a locking function or be a “movable lock” 36.

Signal from microcontroller can raise the stopper inside and release the lock 36 for movement along the closure element or guide, while the user moves the lock manually, following to the instructions of the software program. This stopper can be actuated by an integrated motor or by means of an electromagnet, which are coupled to the microcontroller. Movement of stopper also can be performed on the basis of data received via sensors in the device 36 or external sensors associated with the vending apparatus.

The device 36 can be designed in the form of an autonomous sliding lock which has the ability to automatically move along a guide or closure element using an integrated electric motor, while the user does not need to manually move the lock.

Movable lock 36 can provide access to both individual partitions and a group of partitions with a single closure element. For example, the presence of a single closure element and one movable lock 36 associated with the group of partitions 37 allows sequentially individual access to items of the same type. In this case, the lock 36 opens the partitions in sequence. In the case when a group of partitions 38 with a single closure element has at least two locks 36 able to move simultaneously and cooperatively, then it is possible to store and vend items of different types in such storage partitions. To open the middle partition in group 38 (FIG. 6) two locks should simultaneously move at a minimum distance from each other along the closure element from right to left; upon reaching a storage partition with the selected item, the right lock stops at the right edge of the partition, and the left lock keeps moving until reaching the left edge and then stops. After the item is withdrawn by the user (measured by sensors or managed via time delay), the left lock reaches the right edge of the partition after which the locks can carry out further coordinated movement either to the edge of the locking element, or to open the next partition in a similar way.

The locks 36 (FIG. 6) can receive power both from the external 39 source or through the contacts in closure element 13 on the inside part of vending apparatus or from the internal integrated battery 40. Internal battery 40 is configured to be charged via integrated contacts on the closure element or at a charging station at the edge of the closure element or the guiding rail. If there are several locks 36 on one locking element locks can charge each other contactless or through the ports 41 and 42 at the charging station 39. Governance of working and mechanical elements of the lock 36 can be carried out both by an external controller via wired communication or integrated contacts in the closure element, or by an internal microcontroller 43 installed inside the lock, wirelessly connected with another microcontroller or directly with the user's device. A typical lock 36 may include an electric motor or a stopper 44. Lock movement along the guide or locking element can be carried out by mechanical elements 45, such as gears or rollers. The implementation of lock 36 as a locking element for moving along the zipper, can be carried out without a guide 34, using guide rollers 46 and active mechanical element 45 connected to electric motor. In this case element of a zipper slider 47 is clamped between the part 48 with active mechanical elements and the lower part 49 with rollers 46 by means of fasters 50. Another version of lock 36 for movement without a guide can be implemented through a mechanical system 51, which is designed to be in direct contact with the zipper chains and teeth 52, and movement along the zipper occurs under the action of electric motor 44.

Stationary or movable locks and sensing devices of the vending apparatus can be equipped with tools for receiving or entering various information, including symbolic, signal or biometric (for example, entering a code, holding a button for a certain time duration, a fingerprint sensor), which is compared with control information for opening by means of a microcontroller that can exchange the information with cloud databases on its own or through users' devices.

Microcontroller of vending apparatus can communicate directly with Internet and exchange data from sensors of access management devices with cloud databases of a software program.

The vending apparatus may include removable modules 53 that either combine multiple partitions or include additional devices or accessories 54 such as USB socket, camera, speaker, microphone, visual information (graphics, trademarks, advertisements, etc.). Combining partitions into modules can make it easier and faster to replace them when needed. Replaceable modules with various additional devices or different partitions allow to create modifications of the vending apparatus 55 with different functionality (FIG. 8).

Individual partitions or partition modules are fastened with the elements 56 and are possible to take off the base. Textile fasteners and/or plastic zippers, including fasteners such as “hook & loop” can be also used as such elements. Securing of modules on the vending apparatus base can be carried out using the mount-locking devices 57 located on the device's flat base, which can be combination, electromechanical, baggage or magnetic locks, which fix the module through the blocking of the mount-closure elements 58. Access to the devices 57 can also be organized and secured through the master closure element 59 by blocking the master closure locking elements 60 (via an element functionally similar to the elements 58) that hold the back cover 61 of the vending apparatus. Adjacent partitions inside the module (or vending apparatus) can also be combined if the separator 63 between them is made in the form of a zipper.

The removable modules 53 with grouped partitions associated with a single closure element and a movable lock 36 (FIG. 8) can be organized in a similar way. To remove the partitions module 53 in this case (FIG. 8), the movable devices 36 slides outside the module 53, the mount-locking elements 57 are unblocked, which hold the mount-closure elements (for example, a pull tab) 58, and then fastening elements 56 are opened releasing the modules.

When it is necessary to replace an empty module, the fastening elements 56 allows to easily remove module with a partition (or with several partitions) and replace it with the filled one. These modules can also be filled with goods at distribution centers or directly at factory facilities for the production and packing of vending items. In case of using flexible materials and sealed-in or glued-in plastic zippers, such modules can be directly formed and produced as secondary and group packaging of items for vending and sales.

On the front surface of the flexible flat base facing the user (vehicle passenger or a driver in case of a rented car), graphic or text advertising information can be placed, for example, by printing directly on the surface of the vending apparatus (64) or by inserting graphic materials into transparent pocket 65.

The vending system also contains a tool 66 for mutual identification of a user and a specific vending apparatus of the system, which is usually placed on the front surface of the flexible flat base. The apparatus can be identified by a unique tag (including electromagnetic one) or a unique address (unique information stored at the controller data storage) recognized during the interaction of user's computing device and microcontroller of the vending apparatus via a wireless connection. Device also can have a unique graphic or symbolic (ID or Quick response code, symbolic code, bar code) or replaceable code printed on the device front side of the flexible flat base or placed in a specially designed device compartment, which enables the application software program to match a user and specific vending apparatus in the moment when this code is red by the software.

Vending apparatus design and construction allow using of heat-insulating materials on the inner and/or outer surface of the flexible flat base and inside individual partitions, including metallized films and fabrics, to maintain the temperature of items placed in a storage partition. For cooling of items vending apparatus also can connect to one (or more) flexible pipe or element with a nozzle matching the standard outputs of the climate control system in a vehicle. Conditioned air supply is carried out from the back side of the apparatus and through the systems of channels isolated inside the flexible base, it is supplied to one or more storage partitions, and the outer part of partitions passes cold air due to porosity of a material.

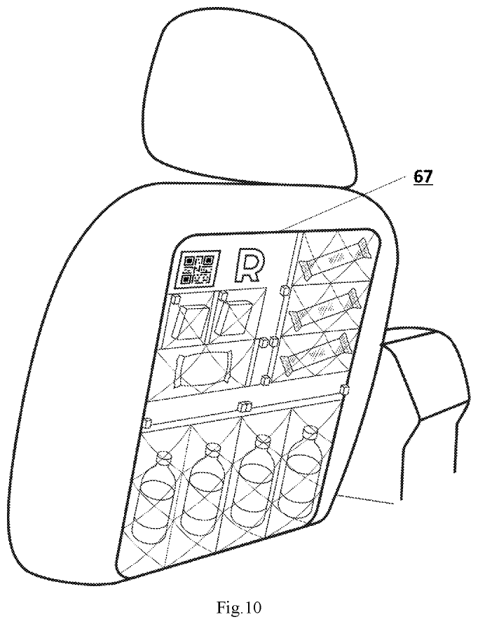

The flat base of vending apparatus can be a part of standard elements of vehicle interior, for example, integrated into the back of a seat or into the chair plastic niche 67 (FIG. 10).

The invention claimed also covers a system for vending items in a passenger vehicle. Such a system includes at least one vending apparatus as per design described above. In general, it is assumed that such vending apparatuses are installed in every vehicle participating in the vending system. Since the vending apparatuses described are easily removable and interchangeable, it is possible to reinstall them in a required vehicle. Vehicles 94 can be independent or used within, for example, transportation management systems 75, such as Uber®, Lyft®, Grab®, GoJek®, DiDi®, YandexGo®, CityMobil® and their analogues, which provide the aggregation and distribution of orders from passengers between individual drivers and transportation services, and provide monitoring, support and processes enabling payment for a ride.

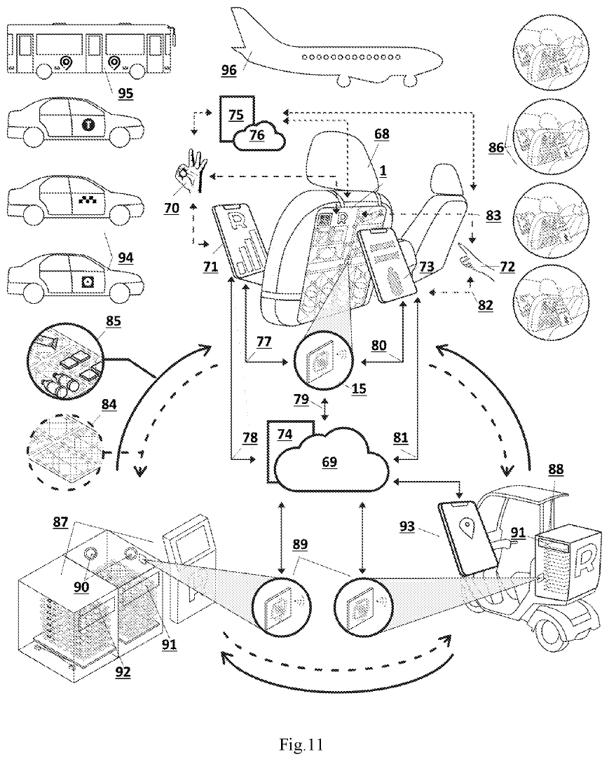

The system for vending items in a vehicle (FIG. 11) includes at least one vending apparatus 1 installed in the vehicle 68, with at least one microcontroller 15, an external data storage 69, computing device 71 of a vending service provider 70, and the computing device 73 of the user 72, equipped with at least one software program 74, facilitating the actions of the participants in the vending system and tools in the vending system and the processes of their interaction. The application program generally carries out interaction of user's device 72 with the vending apparatus and allows step of selecting items, payment for them and their withdrawal. In addition, such application may have additional functions available during the trip, including the support of augmented reality, access to non-physical assets (for example, music and movies), etc. For devices associated with suppliers of vending service, the software program manages communication with the vending apparatus, for example for its maintenance, filling, or for replacing the apparatus or its components. The software program can be installed on computing devices of participants within the system in advance or during their interaction with the vending apparatus. The software program allows exchange of data between devices and service departments for maintenance and filling, centralized management of vending parameters (for example, prices, advertising, bonuses and incentive schemes), management of the inventory matrix (items allowed for vending in the system), tracking the inventory level. Program 74 and data storage 69 of the transport vending system being generally independent of the transportation management system, can, nevertheless, in some implementations interact and exchange data with some transportation management systems or be an integral part of them.

Participants of the in-vehicle vending system are direct users of transportation services (for example, passengers in the case of taxis who may not be connected to the transportation management system 75 and its data storage 76, or drivers and passengers who have rented a vehicle), one or more suppliers of vending services (including participants not directly related to the transportation management system 75 and its data storage 76; a driver himself, who may also not be associated with the transportation system; or other participants in the transportation management system).

Flat structure and foldability of the vending apparatus 1 allows to carry out logistics of empty 84 and filled vending apparatuses 85 in stacked or suspended way, which simplifies the exchange of empty vending apparatuses for filled ones instead of filling the apparatus directly in a vehicle. For example, the system can include several devices (the set 86), and also contain stationary distribution centers 87 or mobile exchange points 88 equipped with their own controllers 89. Equipment at 87 purposed for apparatuses exchange can be automated and contain a controller 89 in combination with control sensors and cameras 90 to collect information about the apparatus provided by a supplier 70 and transfer it to databases 69. When an empty apparatus is placed in the slot 91, the device 1 is automatically collected, its state is identified and its storage partitions with remaining items in them are automatically analyzed by means of the program 74 and of data storage 69. Another filled apparatus is given to a supplier 70 from the slot 92. Mobile points 87 can also be equipped with sensors connected to a controller 89 connected directly to the device of the participant 93, which carries out the logistics of the apparatuses directly between the participants 70, the distribution centers and automated points 87 for exchange of the apparatuses. Array of data from the apparatuses sensors, equipment for apparatuses exchange and devices of participants can be used in the system for general management of inventories.

The steps for use of the vending apparatus by a customer in a vehicle may include the following steps:
1. mutual identification of a user (customer) and vending apparatus in the software program;
2. selection of an items(s) for purchase;
3. payment;
4. opening a storage partition with the selected item;
5. withdrawal of the item;
6. closure of the storage partition;
7. final actions (if necessary).

Other users of the vending apparatus that participate in the vending system (include vending service providers, transportation service providers) handle the logistics of items, filling the vending apparatus, setting prices, customer support, and can also get access to the partitions content.

Having the ability to govern access to each individual item in the vending apparatus, a sale of an item within the vending system can be carried out without the participation of vehicle driver, as well as without interacting with the transportation management system 75 and without any authentication and verification of users in it. This feature allows to vend items in vehicles that provide transportation services within several different transportation management systems or outside of them (for example, taxi fleets that are not associated with ride aggregation services, or individual drivers who do not use rides aggregation services and transportation management systems, as well as drivers carrying out their activities within several such services and the transportation management systems). The same feature allows the installation of vending apparatuses 1 in rental cars or carsharing, autonomous driverless vehicles or in vehicles used by several unrelated users (for example, carpooling, bus, subway or airplane), and meanwhile excludes a need for in-advance user verification or complication of the vending apparatus with additional sensing devices.

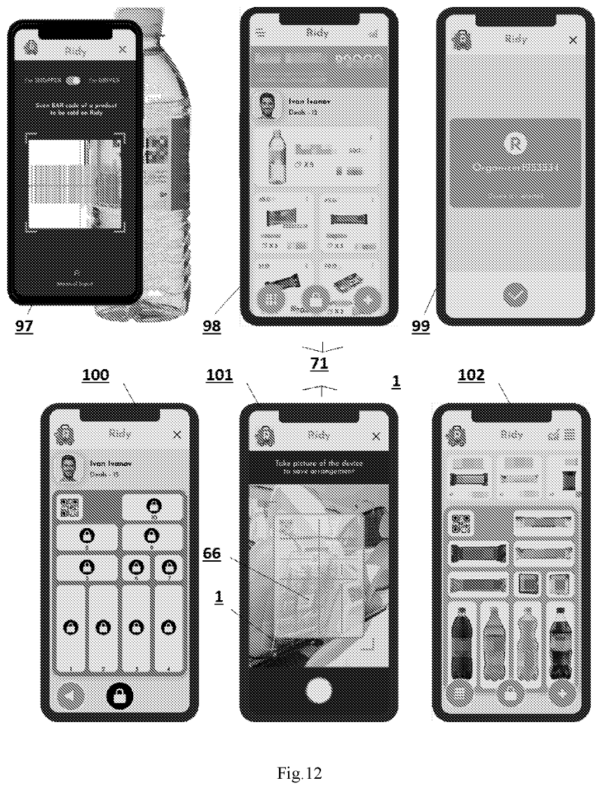

A typical software program interface on a computing device associated with a service supplier 70 (FIG. 12) may include the following functionality: adding items into inventory 97, ability to change the parameters of items 98 (for example, prices, promotions and text information), managing connection 99 to the vending apparatus 1, governance 100 of access management devices 14; automated recording and recognition (101) of a state of the apparatus and inventory in it, as well as registration of newly placed items into the storage partitions; control of vending apparatus appearance and presentation of items in it 102. At the same time matrix of items allowed for vending in the system by one or another supplier and/or in a particular territory can be fixed and is kept in the data storage 69 and may have limited access rights to adjust or add items into it.

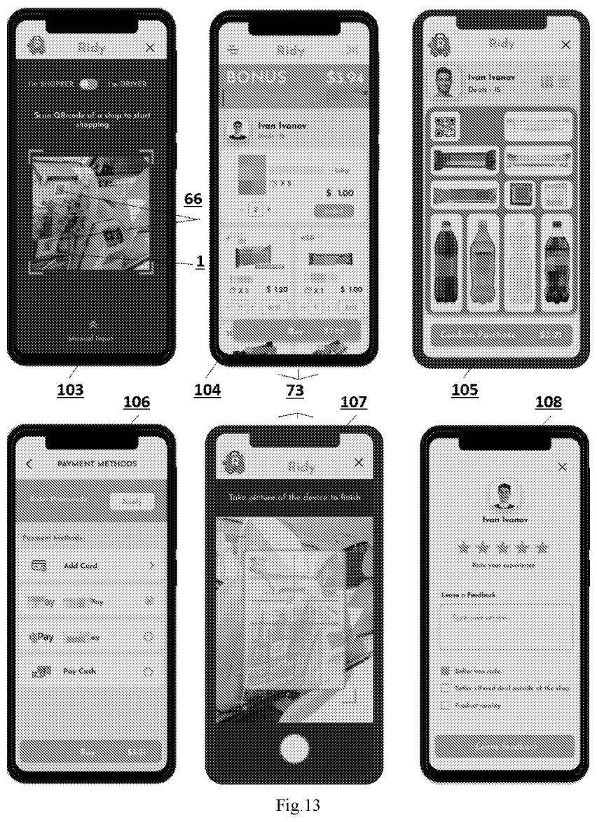

For a user 72, the customer of the vending system, a typical program interface (FIG. 13) may contain: the functionality of automatic identification of vending apparatus 103, selection of items from the inventory of goods 104 or from a graphical representation of the vending apparatus 105, functionality of integrated payment gateway that includes online payment systems 106, automatic recording and recognition of the apparatus state after the withdrawal of items 107, and ability to provide feedback on the service received 108.

Method of vending items in the system comprising the vending apparatus 1, supplier's and user's devices 71 and 73 with an Internet connection can be described as following.

The service supplier 70 fills in advance the storage partitions of at least one vending apparatus with goods and places the vending apparatus in a vehicle. At the same time service supplier 70 may not be associated with the vehicle and may not be the driver. To fill the vending apparatus the service supplier representative gains access to the microcontroller 15 of the apparatus through device 71, for example, by means of identification of the vending apparatus (for example, an individual code) 66 and wireless connection 77, the software program provides access to govern access management devices 14 in the partitions after verifying its access rights in the database 69. The storage partitions can be opened by the supplier through external communication: supplier sends a request via connection 78 from device 71, and the software program matches information about the supplier and its access rights and sends a signal to unlock the partition(s) via connection 79. If the vending apparatus is not equipped with Internet connection module, instead of connection 79, control is carried out directly through connection 77 utilizing, for example, encrypted access codes received over connection 78. Next, the unlocked partitions are filled by the supplier 70. Upon completion of the filling process, supplier 70 performs the final actions directly with the vending apparatus 1 (e.g., via the display interface) and/or on the device 71 in the software program 74. The supplier's final actions with the vending apparatus may include closing the storage partitions via inserting the closure components 22, associated with the closure element 13, into the access-management devices 14. These actions can be carried out automatically in the case of using movable locks 36, using the software program installed on the device 71. Actions of the supplier with the device 71 may also include the visual comparison and matching of the partitions and items in them in the apparatus 1 with their representation in the software program interface on the device 71 to update the database 69. The process of comparison and matching of the physical placement of items and their representation in the software program (and its databases) can be carried out automatically: using the device 71 the supplier takes a picture of the apparatus with placed items, and the software program automatically recognizes graphic information and translates it into information about partitions and items in them, updating the database 69. Due to the flat structure of the apparatus and the transparent material of partitions, the visual information from the image taken can fully describe the inventory of items in the apparatus for vending and their arrangement in partitions. The software program through algorithms, for example, based on the neural network trained against data submitted by users, or as output of other artificial intelligence algorithms, receives the complete digital information about the items in each partition of a particular vending apparatus 1. Data collection on the real inventories in each partition can also be carried out through the standard sensing devices 16-20.

After the final actions, the locking devices of the apparatus are transferred into the locked mode. At the same time program updates the access rights to individual partitions through connection 79. If the vending apparatus does not have a module that provides connection 79, through connections 77 and 78, the software program receives updates and exchanges information about the new access rights and rules to manage each access management device 14 between the local data storage associated with the board controller 15 and global databases 69. For example, in the case of asymmetric cryptographic system is applied, the private keys are stored in the memory of the controllers 15 (specific to each apparatus), and the public keys are securely stored in the storage 69, as well as on the supplier's device 71. The program can also perform regular update and additional encryption of the access rights and rules via connection 79 or connections 77 and 78.

A potential customer (passenger or user of a vehicle in case it's rented) installs during a ride or pre-installs in advance the software program 74 on his/her device 73. User activates the program to make a purchase. Program can also be activated on the user's device and, for example, as well on the vending apparatus itself. If the program is installed on the device 73 in advance, and the user has activated the option of “access without a device”, then the program can be activated through the interface and/or a deice of the vending apparatus. For instance, data input, for example, biometric information, or the input of special control information on the device 14 or other user data, for example, on the apparatus's interactive display, leads to the activation of the software program and its interaction with the data storage through connections 79 or, alternatively, through 77-78, while the selection of items can be carried out directly at the apparatus, since all items in the partitions are visible to the user.

Various interactive communication devices and smartphones can be used as the user's computing devices: devices of the IoT type (internet of things) or device containing individual information with RFID functionality of near field communication (NFC) function, as well as specialized devices, which, serve as a tool for mutual identification of a user and the vending apparatus (after user's registration in the program 74), that store encoded and/or control information and are capable to transmit it to and/or receive it from the vending apparatus beyond other connectivity and data exchange applications. Thus, the user can also activate the software program on the vending apparatus using devices containing individual payment or control information (for example, a credit card with a near-field communication chip, special near-field communication devices, an individual device with an electromagnetic tag possessing the user's public key in the software program 74), by applying them to the corresponding device of the apparatus. In this case, if the freeze of user funds, that are required for deposit in the vending system, is successful, the apparatus microcontroller transfers at least one of its access management devices to the unlocked state and/or monitors the state of the devices 14 for a predetermined time interval.

Another common option of the user's interaction with the vending apparatus is through ordering items from the supplier 70 and paying outside of the vending system payment gateway (for example, with cash or within the alternative online payment systems): the program is activated on the device 71 and opening of the storage partitions occurs through the actions of the supplier. In case the supplier is not present in the process of using the vehicle by the user 72 (for example, an autonomous driverless taxi or a rental car) and the device 73 is not active, the software program can be activated by the user 72 on the device 71, which can also be on-board displays and computing vehicle devices.

In general, the user 72 carries out identification of the apparatus in the software program, for example, by an individual code and his/her own identification.

If the connection 79 is not available in the apparatus, the software program can wirelessly connect the user's device to the microcontroller (connection 80), and thus mediate communication between the apparatus and storage databases 69 via device 73 and connections 80 and 81.

In the program interface (on display of user's computing device, vending apparatus or supplier), user 72 can see the inventory of the apparatus based on the data received from database 69 via connection 81 or, alternatively, from the local storage of controller 15 via connection 79. If the user had preselected option of access without own device, then the selection of items is carried out directly in the vending apparatus and is determined by the software program through the entering of control data on the vending apparatus's devices. User selects items in the software program and makes payment, for example, through the fast payment gateway integrated into the program (while collection of user payment or other personal data may not be performed by the program). In case of successful payment or freezing of the required amount on the account as deposit (including on the basis of data from the storage 69), the software program transmits the access rights to the partitions and/or an encrypted signal to open the locking devices associated with the partitions with paid goods through connection 79 or 80-81. Thus, the locking devices are unlocked automatically. For some configurations user enters control information, for example, via devices 30-31 and then picks up the items from the unlocked storage partition. To do this, user either opens the closure elements 13 manually (in the case of using stationary locking devices 21) or they open automatically (in the case of using movable locks 36).

After paid items are withdrawn the software program may require user to perform final actions 82-83 on the device or the vending apparatus. For example, it may be necessary to close partition closure element and the locking device on the apparatus 1 manually. Program also can ask user 72 to take a photo with the device 73 to analyze later the state of the apparatus and items in it. If the required actions are not performed, the previously frozen funds (deposit) may be debited entirely from the user's account instead of only the cost of the selected product. On the other hand, in case of performing actions, user is provided with an incentive or a bonus. Such actions may be necessary if an opened partition contains a group of items. In this case, an amount greater than the cost of the selected product may be blocked on the user's account at the payment stage as a deposit, and the excess part is released at the user's account upon successful completion of the required actions 82-83. Images and other recorded data can be analyzed automatically by the artificial intelligence algorithms of program 74. Such information can also be used in automatic stocks management and replenishment of the vending apparatus.

After payment and/or completion of actions by user 72, as well as the possible automatic collection of data from the access management devices 14 and its transfer to the storage 69 through connection 79 and/or 80-81, the information on the state of this vending apparatus 1 and the availability of items in its storage partitions is updated in database 69. Partitions access rights are also encrypted and updated if necessary.

The sale can be carried out not only with the help of the locking devices, but also with the use of the sensing devices during a controlled period of time. After initial payment and required sum is deposited, the user can be given with access to more than one individual storage partition with items, and the opening of partitions and withdrawal of items from them can be analyzed using the devices 16-20. Thus, user's actions, for example, withdrawal of items or opening the closure elements of respective partitions, will be a trigger for the final payment (after connection 80 with the device is ended earlier than expected or final actions are completed).

If the user 70 is present in a vehicle together with the user 72 (for example, he is a driver), then if necessary, he/she can also participate in the sales process, for example, when additional confirmation of items availability is needed, before user 72 pays for them.

In the case of using a typical mechanical combination lock as the locking device, the code can be set by the supplier 70 and entered into the software program on the device 71, or, conversely, set in accordance with the software program instructions. Thus, the control code is transferred to the database 69. For automatic verification, photographs of apparatus from device 71 and their automatic analysis in program 74 may be used. After selection of items by user 72 and upon payment, this code is displayed to the user 72 in the software program on the device 73. When the code is entered the partition opens.

The steps of vending items can also take place without access to the Internet. For example, if user 72 has installed the program on the device 73 in advance, and replenished his/her balance in the software program (for example, by subscribing), or the program has frozen the required amount through a payment gateway as deposit, then information on this, including one that is encrypted, or information on the user's status can be stored in the database 69 and transferred to the local storage of controller 15 at the time of communication via connections 77-78, 79 or during one of the previous sessions of accessing the device by another user through connections 80-81. Thus, at the moment of connection of device 73 with the apparatus, controller checks the latest information about the user's device and its balance in program, stored in the controller's memory in advance. After selecting and confirming the purchase on the device 73, the software program compares the user's balance with respect to the selected items and, if it is sufficient, provides the right to access the required partitions either by extracting public keys from the controller storage 15, matching the necessary control information or keys, or using previously saved encrypted access keys to the apparatus and/or its partitions on the local data storage of the device 73. After that, controller and/or software program save the request to withdraw funds from the user's balance, which is sent to the database 69 at the moment when communication with the Internet is restored, either through connections 77-79 or 79, or 80-81. This feature can be used to carry out the operation of the vending service and the apparatus in conditions of limited communication with Internet 96, for example, in intercity taxis or buses, planes or trains.

The purchase of items can also be conducted in the absence of the user's computing device during the trip. User pre-enters payment data into the program, as well as enters or receives identification information, while access to the partitions will be provided based on the exchange of the required information through connection channels 79 or 77-78 (exchange will be postponed in time if the vending service provider is not in the vehicle during the ride or the Internet connection is absent) or via matching the necessary identification data of authorized users saved in the microcontroller in advance. For example, entering of the individual control information, (e.g., biometric data) into the devices of the apparatus will be a signal to compare the received information with the control data on the local storage of the controller 15 and, in case of matching it will trigger payment signal and opening of an individual storage partition with the desired item.

### Example of an Implementation

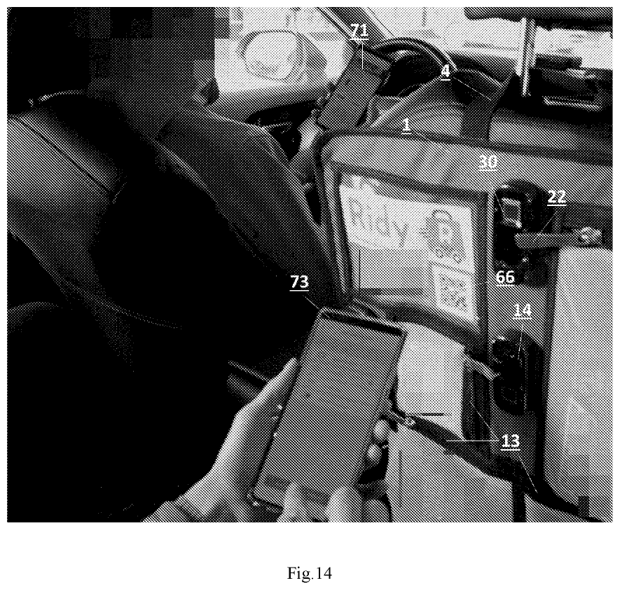

The invention claimed is implemented in a prototype which is being tested in taxi services in cities of Moscow, Krasnodar, Sochi and Omsk of Russian Federation. The vending apparatuses of the system prototype are designed in the form of car seat organizers (FIG. 14; 1) with the flat base of 430×580 mm, made of four layers containing textile materials and pressed hydrophobic cardboard in stiffening inserts (300 g/cm2). On the front side facing a user there are partitions (from 5 to 10, depending on the apparatus model under testing), all partitions are sewed to the base by means of nylon threads and are made of mesh stretch material of low density and thread thickness with a mesh size of 2 mm. One apparatus model includes two partitions that are made as the group type where one can place several items. Each storage partition contains a closure element, that is made as zipper with a width of 8 mm and a slider with a pull tab, which in closed state of a storage partition is inserted into the lock-sensing device. The lock-sensing devices are made of two parts and mounted crimping the first and third layers of the apparatus's flat base. The fourth layer is a cover, and the second contains cardboard inserts under each partition. Locking and lock-sensing devices of the vending apparatus are made on the basis of bodies and blocking mechanisms of standard luggage locks such as Samsonite®, eGeeTouch®, YC Smart® and Fipilock®. The locks are equipped with 1.5V (direct current) low speed miniature motors M10 with planetary plastic gear from Shen Zhen Ke Gu Technology Co. They set in motion the locking mechanisms of stationary devices 21. The locks are equipped a miniature electric motor, the moving and stationary parts of a locking mechanism, that are set in the specific way, that during its operation detectable changes (but not yet harmful for the device) appear in properties of the electric current in circuits associated with the lock and the motor, and those changes can be used as indicator of relative position of the locking elements or the information to accurately manage state of the lock via the main controller. One of the devices contains a sensor based on the Grow® capacitive fingerprint scanner and an integrated additional controller for processing and transmitting of information in a wired connection with the main controller that uses esp32 processor among other components.

The module for analysis of the electric current properties in a circuit associated with each lock is deployed at the controller. Unlocking/locking mechanism within the device is based on the principle of analyzing information obtained from electric current properties (current and voltage) in the circuits associated with each motor. When a frame responsible for actuation of opening mechanism components of the lock, that is connected to the motor, points and presses the special stopping element inside, the electric current spikes. The spike of current when certain threshold is reached is detected and triggers motor's stoppage and then reverse rotation of the motor places the frame and the actuator into the initial position. Thus, electric current 27 is used as an information source 29 to detect and control state of opening of the locking devices.

The microcontroller is connected to each lock-sensing device (both types: locks and lock-sensors) via a wired connection (inside the flat) and contains Bluetooth module for connecting with external devices. The device is equipped with a USB-port for charging users' devices. Each device is equipped with a cable with a USB connector of 1.5 m long for powering devices and components of the apparatus from the standard vehicle's power supply socket. Devices have unique identification codes translated into quick response codes (QR), which are recognized by the software program on users' devices. Prototype software has several modules. The module that controls the controller and ensures the operation of the apparatus' devices is written in C++. Program module installed on the user's devices is written in JavaScript in the cross-platform ReactNative framework. External databases and their algorithms are executed in the free relational database management system MySQL using PHP language and implemented on the Amazon Web Services platform.

The apparatus claimed, as well as the system based on it, are characterized by a high degree of ergonomics, transformability and modularity of elements, which helps to simplify the transportability of the system elements (vending apparatus), to increase the safety and integrity of the system in operation (both from a user's and from a supplier's side).

Among other things, the listed properties lead to an increase in the efficiency of processes at the main stages of the life cycle of the vending apparatus, from its installation, filling, replacement and transportation to the possibility of its installation in almost any vehicle type.

1. A vending apparatus, capable of being placed onto an interior of a vehicle cabin comprising a realization of the vending apparatus as a portable and/or transformable device for storage and sales of items, where said vending apparatus comprising:
a flat base, where elements of said apparatus can be mounted to;
a plurality of storage partitions, mounted to the front side of said flat base, where each of said partitions can contain at least one item of goods, that can be purchased, and possesses possibility of individual access by a user;
a closure element that secures at least one said partition by reversible fastening of an edge of the said partition to said flat base;
an access-management device associated with said closure element comprising functions of a sensor (the sensing device) and/or a lock (the locking device) and/or a lock-sensor, which are able to control fastening of at least one said partition and capable of exchanging signals or data with external devices;
a controller board connected to at least one said access-management device and able to manage its operation by exchanging data or signals comprising functionality of receiving signals from a user of the apparatus directly or via a computing device associated with a user.

2. The vending apparatus of claim 1 comprising its medium for storage and sales of items that can be placed on the back of at least one seat or between adjacent seats of a vehicle.

3-6. (canceled)

7. The vending apparatus of claim 1 comprising additionally mounted tools, such as electric charger for external devices and/or backlight and/or interactive modules, including an information display screen, microphone or speaker.

8. (canceled)

9. The vending apparatus of claim 1 comprising its said locking devices, that are made as electromechanical or magnetic or combination locks.

10. The vending apparatus of claim 1 comprising its said locking devices, that are made as sliding or movable locks, that once unlocked can be moved manually by a user, or slide automatically along the closure element, and manage access to the several said storage partitions simultaneously.

11. The vending apparatus of claim 1 comprising said access-management devices made as autonomous sliding locks, associated with their own micro controllers, that are able to provide access to several said storage partitions independently.

12. (canceled)

13. The vending apparatus of claim 1 comprising said access-management devices made as sensors capable of registering moment of opening/closing of said storage partitions and/or the presence/absence of items in the storage partition, and/or the integrity/authenticity of the item in the storage partition, and are connected to the controller associated with the said partition.

14-20. (canceled)

21. The vending apparatus of claim 1 comprising the flat base used as a part of the seat cover or other elements of the vehicle interior.

22-24. (canceled)

25. A system for vending items in a vehicle cabin, the system comprising:
at least one said vending apparatus of claim 1;
computing devices of a user and/or a supplier, equipped with a software program that enables data exchange with the database of the vending system;
a tool for identification of a specific vending apparatus and/or a specific user.

26. The system according to claim 25 comprising said identification tool as unique tag, ID, Quick Response (QR) code, symbolic code, bar code.

27. (canceled)

28. The system according to claim 25 comprising at least one distribution center, that manages storage and/or shipment of items being sold or the apparatuses in the vending system, which uses the software program that facilitates exchange of data with the vending apparatuses and/or computing devices of users and/or suppliers.

29-30. (canceled)

31. A method of vending items in a vehicle cabin using the system of claim 25, the method comprising:
installation of at least one vending apparatus of claim 1, which has the storage partitions filled with items for sale, into at least one vehicle cabin;
update of information on the items placed in a specific vending apparatus installed in a specific vehicle in the data base of the vending system;
activation by a user of the software program that enables and facilitates selection of items and a payment process;
simultaneous identification of the user and the vending apparatus located in the vehicle;
selection of items and payment for them facilitated by the interface of the vending apparatus and/or the software program;
providing user the access to the storage partitions with the selected and paid product, followed by its withdrawal from the partition.

32. The method of claim 31 comprising the identification of the vending apparatus by the user's computing device done via scanning or entry of the code associated with the vending machine into the software program.

33. The method of claim 31 comprising the activation of software program through the interface of the vending apparatus.

34. The method of claim 31 comprising the activation of the software program via the user's computing device.

35. The method of claim 31 comprising preliminary registration of the user's computing device in the software program, while identification of the user by the vending apparatus occurs based on identification data, including biometric and payment related information, which have been pre-filled in the software program prior use intended use of the vending apparatus.

36. The method of claim 31 comprising the payment process carried out via subscription, or code unique to the user, voice, phrase and/or payment data, including those that are entered in advance into the software program.

37. The method of claim 31 comprising the payment process that is carried out using contactless payment methods or fast payment services.

38. The method of claim 31 comprising the payment process that is carried out automatically in accordance with the user's payment details entered into the software program in advance.

39. (canceled)

40. The method of claim 31 comprising the access to the storage partition carried out based on entry of a code provided to the user by the software program.

41. The method of claim 31 comprising step of recording of the state of the vending apparatus by registering signals from the access-management device of the vending apparatus before and after the sale.

42. The method of claim 41 wherein recording of the state of the vending apparatus comprises taking photographic image of the vending machine by a user or supplier of the vending system.

43. The method of claim 41 comprising the use of information, obtained during recording of the state of the vending apparatus, for interpreting actual inventory of items in the vending apparatus, which is then submitted to the distribution center for decision-making on need for replenishment of the inventory in the vending apparatus or replacement of the vending apparatus.

44. (canceled)
